(19) United States
(12) Patent Application Publication
(10) Pub. No.: US 2019/0203822 A1
(43) Pub. Date: Jul. 4, 2019

(54) CONTROLLED- OR ZERO-BACKLASH GEAR REDUCER

(71) Applicant: Luis Maria Antonello, Roma (IT)

(72) Inventor: Luis Maria Antonello, Roma (IT)

(21) Appl. No.: 16/325,230

(22) PCT Filed: Aug. 8, 2017
(86) PCT No.: PCT/IT2017/000167

§ 371 Date: Feb. 13, 2019

(30) Foreign Application Priority Data
Aug. 16, 2016 (IT) 102016000085441

(51) Int. Cl. F16H 55/24; F16H 1/22; F16H 57/01; F16H 57/12

(52) U.S. Cl. CPC F16H 55/24; F16H 1/225; F16H 57/01; F16H 37/065; F16H 2057/012; F16H 2057/122; F16H 2057/123; F16H 57/12

(57) ABSTRACT

A controlled or zero backlash gearmotor comprises a main gearmotor, a secondary service gearmotor, an electronic control unit and transmission and synchronization gears. The backslash control results from the cooperation between the main gearmotor, the secondary service gearmotor, and the electronic control unit which adjusts, based on parameters detected by a series of sensors, the load provided by the service gearmotor on one of two irreversible screws pressing on two worm screws, respectively, arranged at the side of a worm wheel. This latter supports a secondary shaft and is get into gear with both the worm screws, the two worm screws being synchronized by means of gears connecting them to each other so that a reversible motion transmission is executable.

The invention refers to the field of speed reducers. More specifically, it refers to a worm and helical wheel gear reducer which, in operation, tends to achieve a basically zero backlash in speed reduction.

Speed reducers are mechanical devices forming part of mechanical power transmission. Generally, they consist of a series of gears housed inside a shell (bearing body), the gears reducing rotational speed from an input shaft (or high speed shaft) to an output shaft (or low speed shaft) and forming a gearmotor if coupled with an engine.

Such devices, mostly consisting, as previously mentioned, of gears which transform the rotational speed of motors to which they are associated, are used everywhere in the modern technique and in some cases it is necessary for the hysteresis or backlash between motion input and output to be minimal or preferably equal to zero.

According to the prior art a worm gearmotor generally comprising:

A. a bearing body;

B. a gear reducer drive motor;

C. a mechanical part (named as kinematic chain) consisting of a worm screw and a helical wheel. Worm screws

[symbol]

Gearmotors with such type of configuration are employed in every field of the modern technique and electronic control systems handle all kinds of mechanical equipment, resulting in what is called “Mechatronics”.

There are fields wherein highest precision in transformation (reduction or amplification) of the angular velocity of motors is required, such as:

1. Robotics

2. Computer Numerical Control (CNC) Machines

3. Scientific Laboratory Equipment

4. Optical Systems, Pointing Systems

5. Stabilization Systems

6. Astronomical Systems, etc.

The list is very long and includes every area of the technique. Therefore, having gearmotors in which there is a two-way relationship with zero hysteresis between the high speed shaft (drive shaft) and the low speed shaft (driven shaft) is of paramount importance.

### GENERAL DESCRIPTION OF THE INVENTION

The object of the present invention is to provide motion transmissions with motion reduction or multiplication, characterized by a total absence of backlash between input shafts (drive shaft) and output shafts (driven shaft).

This and other objects, which will be clear throughout this description, are achieved through the herein described invention composed by a combination of gears and in particular by worms (the term “worm” is hereinafter used to designate the transmission components formed by a single shaft in the central section of which are obtained the actual worm screws), helical wheels and toothed wheels, arranged in such a way as to obtain the backlash elimination by means of a mechanism capable of changing its operating conditions by adapting to cogent requirements in real-time and capable of adapting to changing needs during gear reducer operation.

This is achieved by introducing a gearmotor electronically controlled having the function of regulating preload which eliminates backlash between transmission gears; in addition, two load cells having a dual function were used:
The first function is to measure the zeroing load or preload,
The second function is to monitor the load status or torque transmitted by the transmission assembly during normal operation.

By so doing, electronic control/monitoring systems can detect abnormal operating conditions and proceed with reporting such abnormal conditions or stopping the system. This takes into account temperatures, loads, performance optimization, etc.

The “screw adjustment” gearmotor varies the loop closing load (continuous cycle) based on an electronic control unit command. The control unit collects information from a series of sensors arranged in the kinematic chain and optimizes their operation in real-time, by monitoring working conditions and communicating the gear reducer status to the “exterior” so as to perform monitoring from a higher level and operate in order to change operating conditions to prevent faults in advance.

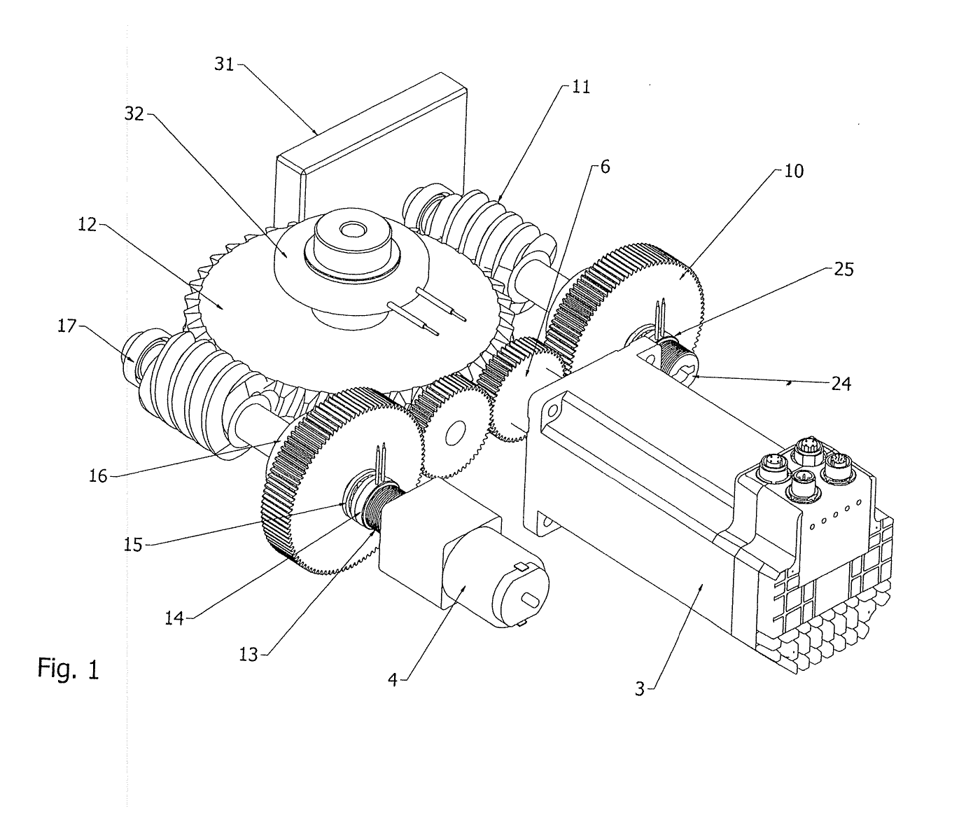

This control unit, hereinafter also referred to as “MECHATRONIC GEARMOTOR”, is in principle composed by the following elements (FIG. 1):

1. motor quadrature encoder with a low speed shaft encoder (an encoder is a digital electronic component, the simplest version thereof consists of a “i” number of inputs and a “n” number of outputs with i≤2ⁿ). The Electronic Control Unit compares the Motor Encoder with the Low Speed Shaft Encoder, measures the actual backlash between the two last ones, and regulates the preload on the kinematic chain by acting on the operating gearmotor.

2. Load cells for measuring the instantaneous operating torque and the preload for backlash zeroing.

3. Internal Temperature Sensor

4. External Temperature Sensor

5. Vibration Sensor

6. Oil level Sensor

7. LAN/WiFi Connection

The above described elements organization results in an absolute precision gearmotor, a real Mechatronic device, which provides a bidirectional and constant electronic control of the instantaneous torque, an electronic preload optimization and a backlash zeroing, as well as all parameters with reference to the gearmotor internal/external temperature.

The previously mentioned objectives are achieved by means of a controlled-backlash gear reducer as claimed in claims 1 to 11.

To provide a detailed description of the embodiments of the invention, the accompanying drawings will be now considered, in which:

FIG. 1 shows the present invention with all its essential elements.

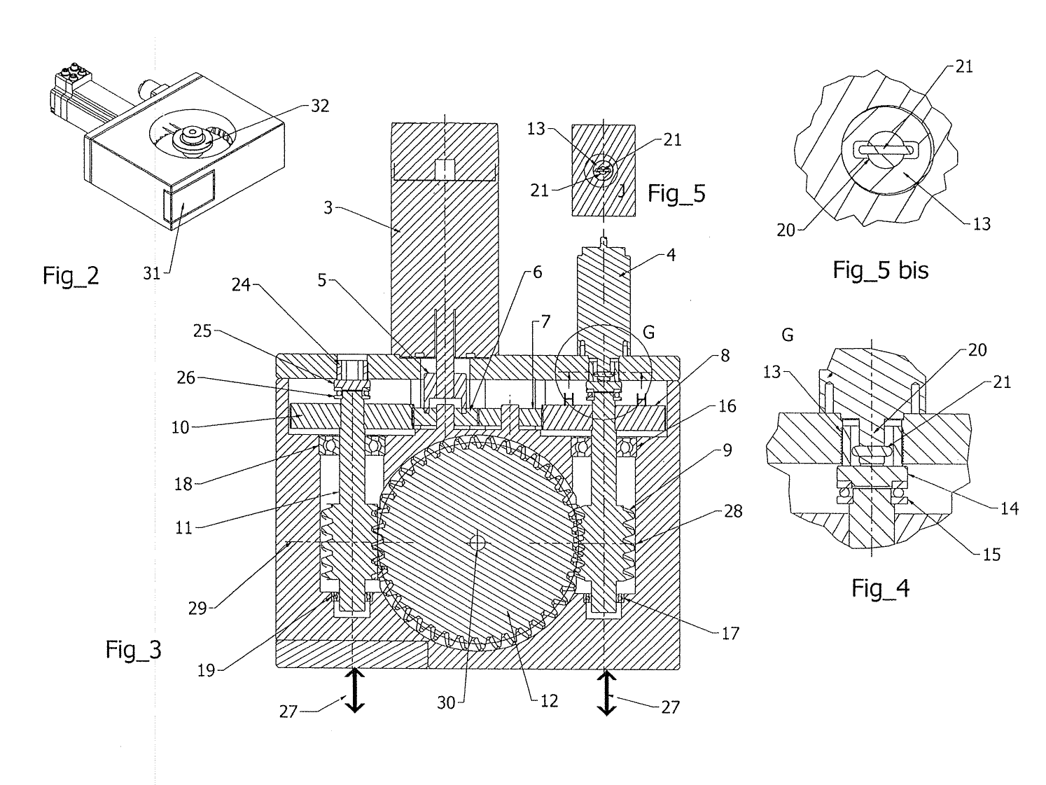

FIG. 2 shows the gear reducer according to the present invention with the electronic control unit 31 and the encoder 32 clearly visible.

FIG. 3 is the same gear reducer shown in FIG. 2, but sectioned in its height according to a median plane so that it is possible to clearly see the placement of its constituent parts.

FIG. 4 is an enlarged view of the “G” area, allowing to see how the (operating gearmotor 4) shaft 20 engages the right preload screw 13 by mean of a pin 21.

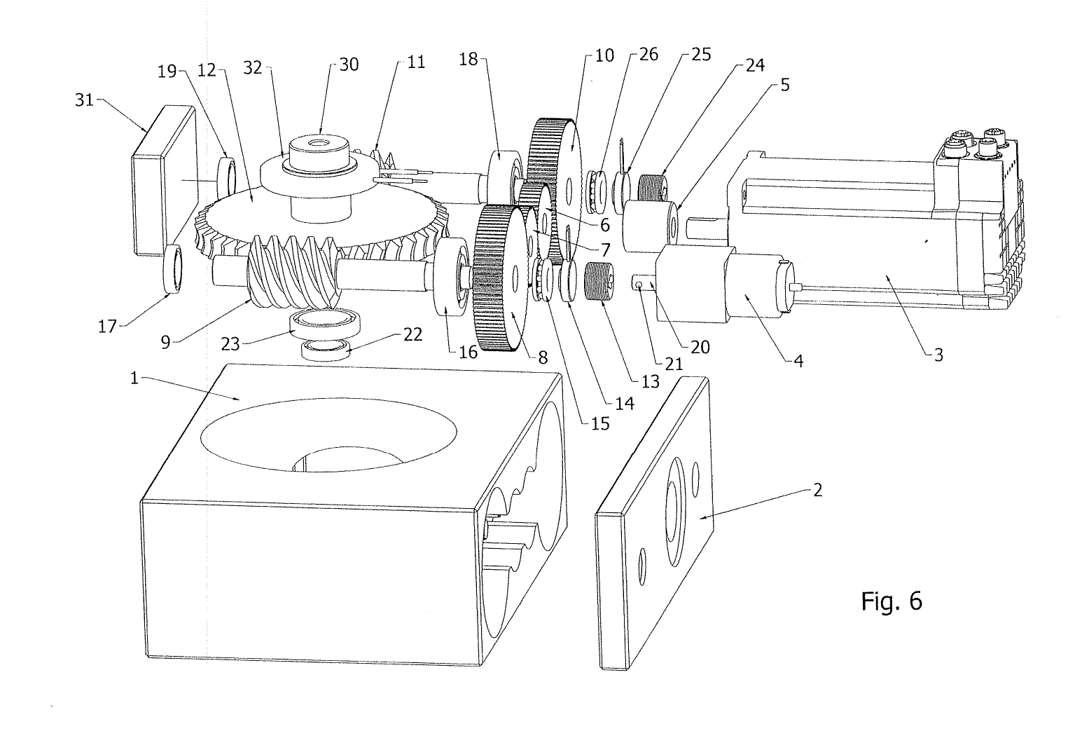

FIG. 5 is a sectional view of the G-area, taken along the line H-H, which allows to see how the shaft 20 and the pin 21 engage together a slotted hole in the right preload screw 13 in order to transmit (by acting as a screwdriver on a screw) their rotating motion to mentioned preload screw; the figure shows the shaped hole of the preload screw. (See FIG. 5bis)

FIG. 6 is an exploded axonometric view of the invention, clearly showing all the essential elements the numbering of which is provided hereinafter (said numbering also applies to FIGS. 1, 2, 3, 4, 5, 6 and 5bis).

### DESCRIPTION OF THE OPERATING MODE

The shaft/worm screw 9 rotates on bearings 16 and 17, where it is free to rotate and slide axially according to the arrows 27 direction, similarly the worm screw 11 rotates on bearings 18 and 19 and is also free to rotate and slide axially according to the arrows 27.

Moreover, at the assembly, worm screws' midlines 28 and 29 coincide with the rotational axis 30 of the helical wheel 12.

Finally, with the elements arranged in such a manner, the (left) preload screw 24 is adjusted to be in contact with the (left) load cell 25 and the (left) thrust bearing 26 and the latter one is in contact with the worm screw 11.

Under these conditions, if the operating gearmotor 4 is activated to cause, through a drive pin 21, a screwing rotation of the preload screw 13 it will be achieved that both load cell 14 and (right) thrust bearing 15 will press together on worm screw 9 forcing it to move forward and thus press on the helical wheel 12 teeth sides (helical wheel which is mounted on the shaft 30 guided on bearings 22 and 23) and said helical wheel will in turn be rotated.

Preload screw 13 advancement will stop when the teeth of all gears forming the circuit will come into contact with each other as a result of the helical wheel 12 rotation by mean of worm screw 9 and the rotation of worm screws 9 and 11 themselves, said rotation being determined by the worm screws' reversibility that will close the path which connect gears 8-9-12-11-10-6-7 and still 8.

By continuing operating gearmotor 4 rotation, having all parts in contact with each other, load cells 14 and 25 will start to measure the induced preload.

At this point, when a prescribed preload value for a specific working condition will be reached, electronic control unit 32 (FIG. 1) will stop the operating gearmotor 4 and will be able to change the preload value by rotating in an appropriate direction to increase or decrease said preload value based on the achieved working temperature or changed working conditions.

The encoder 32 associated with helical wheel 12, as well as the Temperature Sensor and any other sensors, not indicated herein, are connected to the electronic control unit.

In particular, the Encoder 32 allows control unit 31 to compare a motor 3 and helical wheel 12 rotation, especially when the system is switched on, to check and, if necessary, correct the system preload status. (Test—Preset function).

Further, in a preferred embodiment, there is an operating gearmotor 4 which is connected to one of the two irreversible adjusting screws, said operating gearmotor works by increasing or decreasing the load on the associated screw and consequently on the entire gear train due to gear train reversibility which is previously set as a condition.

Actually, it was indicated with the number 4 an operating gearmotor on one of the two irreversible adjusting screws since this is the basis of the invention and the minimum condition for the kinematics to be functional.

It is equally evident that, due to particular operating needs, it will be possible to insert two gearmotors, each of which acts on one of the two adjusting screws, as well as an operating gearmotor which acts on both the adjusting or preload screws, by using an element for transmitting and synchronizing the operating gearmotor motion simultaneously on both the adjusting screws.

### Advantages and Industrial Validity of the Invention

Electronic control unit 31 is capable of controlling a variety of sensors and functions adapted to monitor instantaneous operating conditions, such as:
Kinematic backlash (Main and Secondary Encoder Monitoring)
static and dynamic charges exerted on the kinematics teeth (load cells monitoring)
temperature
oil level
etc.

Electronic control unit 31 includes the circuits for bidirectionally communication with the outside by a LAN and WiFi network connection, in order to allow for gearmotor remote monitoring, all functional parameters reception by a control room as well as the control room capability to change and vary gearmotor functional modes adapting them to current requirements.

### REFERENCE NUMBERS

1 Gearmotor bearing body
2 Closing cover of the bearing body
3 Main motor (of the gear reducer)
4 Operating gearmotor (preload regulating gearmotor)
5 Main motor joint
6 Gear (smaller toothed wheel)
7 Gear (smaller toothed wheel)
8 Gear (greater toothed wheel)
9 Shaft/worm screw
10 Gear (greater toothed wheel)
11 Shaft/worm screw
12 Helical wheel
13 Right preload screw
14 Right load cell
15 Thrust bearing
16 Bearing of the worm screw 9
17 Bearing of the worm screw 9
18 Bearing of the worm screw 11
19 Bearing of the worm screw 11
20 Shaft of the operating gearmotor 4
21 Drive pin on the shaft 20
22 Bearing of the helical wheel 12
23 Bearing of the helical wheel 12
24 Left preload screw
25 Left load cell
26 Left thrust bearing
27 Arrows of the worm screw sliding direction
28 Midline of the worm screw 9
29 Midline of the worm screw 11
30 Rotational axis of the helical wheel 12
31 Electronic control unit
32 Encoder

1-11. (canceled)

12. A gear and motor system for controlling backlash, said system comprising:
a first worm screw axially moveable by rotation of a first screw, and a second worm screw axially moveable by rotation of a second screw, said first and second worm screws being rotationally synchronized by way of one or more synchronization gears connecting them to each other so that a reversible motion transmission is executable, wherein at least one of said synchronization gears being operably associated with a main motor;
a secondary motor operably associated with said first screw or said second screw;
a worm wheel including an output shaft, said worm wheel being operably engageable with said first worm screw and said second worm screw; and
an electronic control unit configured to control backslash resulting from cooperation between said main motor, said secondary motor and said electronic control unit, said electronic control unit being configured to control at least said secondary motor by adjusting a load provided by said secondary motor on said first screw or said second screw, based on parameters detected by one or more sensors.

13. The gear and motor system according to claim 12, wherein said first screw and said second screw are irreversible.

14. The gear and motor system according to claim 13, wherein said secondary motor simultaneously and synchronously adjusts both said first and second screws contrasting said first and second worm screws, respectively.

15. The gear and motor system according to claim 12 further comprising a second secondary motor associated to one of said first and second screws, with said secondary motor associated to the other of said first and second screws contrasting both said first and second worm screws, respectively.

16. The gear and motor system according to claim 12, wherein said first worm screw included a first drive shaft, and said second worm screw includes a second drive, each of said first and second drive shafts being slidable along a respective guide.

17. The gear and motor system according to claim 16, wherein said secondary motor is configured to rotate said first screw that is configured to apply an axial thrust on the first drive shaft of said first worm screw, and wherein a ratio between said first and second worm screws and said worm wheel being dimensioned in order to constitute a reversible motion transmission, herein the axial thrust due to rotation action of said secondary motor provides said second worm screw to abut on said second screw, and being the transmission reversible, simultaneous pressure on both said first and second screws, generates a rotatory component of said first and second worm screws and a pair of intermediate timing gears of said synchronization gears.

18. The gear and motor system according to claim 17, wherein said secondary motor operation is stopped, by way of said electronic control unit, when said first and second worm screws, said synchronization gears and said worm wheel are in contact to each other, thus resulting in chain forces being closed and a transmission backlash being equal to zero.

19. The gear and motor system according to claim 16, wherein said first and second drive shafts each rotates on a bearing configured to allow free rotation and slide axially said first and second worm screws, respectively.

20. The gear and motor system according to claim 19, wherein a median line of said first form screw and a median line of said second worm screw determine a rotation axis of said worm wheel.

21. The gear and motor system according to claim 16, wherein said first and second screws each includes a bore defined therethrough and at least one slot defined therethrough in communication with said bore, said bore is configured to receive said first and second drive shafts, respectively, and said slot is configured to receive a pin associated with aid first and second drive shafts, respectively.

22. The gear and motor system according to claim 12, wherein said first and second screws each is configured to receive a transmission coupling pin associated with a shaft of said secondary motor, and located between said first and second screws and their respective said first and second worm screws is a load cell and a thrust bearing.

23. The gear and motor system according to claim 22, wherein said load cell associated with each of said first and second worm screws is in electrical communication with said electronic control unit for detecting in real time loads applied on said first and second worm screws in order to optimize load values of the load applied from said secondary motor.

24. The gear and motor system according to claim 12, wherein advancement of said first screw or said second screw stops when teeth of said first and second worm screws, said synchronization gears and said worm wheel are in contact with each other as a result of rotation induced on said worm wheel by action of said secondary motor and rotation of said first and second worm screws, the rotation being determined by the reversibility of the latter ones providing a kinematic path of said first worm screw, said second worm screw and said synchronization gears.

25. The gear and motor system according to claim 12, wherein said control unit is configured to compare information of a motor encoder associated with said motor with information from an encoder integral with said worm wheel and said output shaft.

26. The gear and motor system according to claim 12, wherein said control unit electronic control unit including a circuitry configured to communicate bidirectionally with external units, by way of LAN and/or WiFi network connections, in order to allow for monitoring said system remotely, by receiving all operating parameters in a control chamber as well as by a capacity of said control chamber to change system operating modes.

27. The gear and motor system according to claim 12, wherein said first and second worm screws are free to slide axially with reciprocal linear motion, being connected to each other by said worm wheel with an inverse ratio, with said first and second screws pressing simultaneously through the intermediation of a load cell and a thrust bearing associated with each of said first and second worm screws.

28. A gear and motor system comprising:
a main motor;
a first axially moveable worm screw, and a second axially moveable worm screw;
one or more synchronization gears connecting said first and second worm screws so as to be rotationally synchronized so that a reversible motion transmission is executable, wherein at least one of said synchronization gears being operably associated with said main motor;
a first screw configured to apply axial movement to said first worm screw upon rotation of said first screw;
a first load cell and a first thrust bearing arrangement connected between said first screw and said first worm screw;
a second screw configured to apply axial movement to said second worm screw upon rotation of said second screw;
a second load cell and a second thrust bearing arrangement connected between said second screw and said second worm screw;
at least one secondary motor operably associated with said first screw or said second screw;
a worm wheel including an output shaft, said worm wheel being operably engageable with said first worm screw and said second worm screw; and
an electronic control unit configured to control backslash resulting from cooperation between said main motor, said secondary motor and said electronic control unit, said electronic control unit being configured to control at least said secondary motor by adjusting a load provided by said secondary motor on said first screw or said second screw, based on parameters detected by one or more sensors.

29. The gear and motor system according to claim 22, wherein said first and second load cells each being in electrical communication with said electronic control unit for detecting in real time loads applied on said first and second worm screws in order to optimize load values of the load applied from said secondary motor.

30. The gear and motor system according to claim 16, wherein said first and second screws each includes a bore defined therethrough and at least one slot defined therethrough in communication with said bore, said bore is configured to receive said first and second drive shafts, respectively, and said slot is configured to receive a pin associated with aid first and second drive shafts, respectively.

31. A method of using a gear and motor system for controlling backlash, said method comprising the steps of:
a) rotating a worm wheel by way a main motor operably associated to at least one gear in a synchronization gear assembly that is operably associated to rotatably synchronize a first worm screw and a second worm screw that are both operably associated with said worm wheel;
b) axially moving said first worm screw by way of a rotating a first screw by way of a secondary motor operably associated with said first screw, said first screw being configured to apply force to said first worm screw upon rotation of said first screw; and
c) controlling said secondary motor by an electronic control unit configured to control backslash resulting from cooperation between said main motor, said secondary motor and said electronic control unit based on parameters detected by one or more sensors.
